(19) United States
(12) Patent Application Publication
(10) Pub. No.: US 2024/0422483 A1
(43) Pub. Date: Dec. 19, 2024

(54) AUDITORY MONITORING METHOD USING HEARING AID EARPHONE, AND SYSTEM THEREFOR

(71) Applicant: OLIVE UNION, INC., Seoul (KR)

(72) Inventor: Myung Geun Song, Seoul (KR)

(73) Assignee: OLIVE UNION, INC., Seoul (KR)

(21) Appl. No.: 18/708,783

(22) PCT Filed: Nov. 11, 2022
(86) PCT No.: PCT/KR2022/017780

§ 371 Date: May 9, 2024

(30) Foreign Application Priority Data
Nov. 11, 2021 (KR) 10-2021-0154571

(51) Int. Cl. H04R 25/00

(52) U.S. Cl. CPC H04R 25/48; H04R 25/554; H04R 2225/49; H04R 2460/01

(57) ABSTRACT

The present invention relates to an auditory monitoring method linked with a hearing aid earphone so as to provide personalized monitoring for hearing improvement by analyzing hearing habits in a hearing mode and a music mode, and a system therefor, the method comprising the steps of: detecting a hearing mode of a hearing aid function and a music mode of an earphone function according to a selection input of a user; measuring hearing habits including external noise level and exposure time in the hearing mode and music volume level and exposure time in the music mode; and analyzing the hearing habits so as to perform personalized monitoring for hearing improvement in each of the right ear and the left ear of the user in the hearing mode and the music mode.

### TECHNICAL FIELD

The present invention relates to an auditory monitoring method and system using a hearing aid earphone, and more particularly, to technology for analyzing hearing habits in a hear mode and a music mode in linkage with a hearing aid earphone and providing personalized monitoring for hearing improvement.

### RELATED ART

Recently, with the rapid development of biomedical technology, patients who previously did not receive much help from wearing hearing aids have been able to improve their hearing by selecting and wearing appropriate hearing aids.

Among medical devices, the hearing aid is a cutting-edge medical device that is always attached to the body for use. The hearing aid needs to be steadily managed according to a change in hearing and to receive after-sales service (A/S) for damage caused by moisture and foreign substances in the ear. Therefore, the hearing aid is considered one of the most important biomedical technologies.

The existing hearing aid is in the form of a trumpet-shaped sound collector, but the form of an electric hearing aid that helps amplification of sound is currently used. Also, for the hearing aid, there is a bone conductive type that is mounted on the mastoid part, but an airway type structure is generally used. Such hearing aid receives sound wave through a microphone, converts the same to electric vibration, magnifies the same, and converts the sound wave back to an earphone to be heard by ear.

Recently, research is being conducted on a more powerful exclusive hearing aid processor. The exclusive hearing aid processor has a processing rate and a memory that are more than twice as fast as the existing processor and includes small chips and parts with advanced nano technology.

However, since the existing technology for hearing aids was set based on hearing data of persons with difficulty of hearing (hereinafter, “user”), there was a limitation in that data on the user's real-time surrounding noise is not applied. Also, the existing technology for hearing aid has a limitation of providing only limited functions to hearing aids.

### DETAILED DESCRIPTION

### Technical Subject

An objective of the present invention is to verify hearing habits of a user in a hear mode of a hearing aid function and a music mode of an earphone function in linkage with a hearing aid earphone and to provide a personalized monitoring service for hearing improvement.

### Solution

An auditory monitoring method for monitoring a hearing status of a user in linkage with a hearing aid earphone according to an example embodiment of the present invention includes detecting a hear mode of a hearing aid function and a music mode of an earphone function according to the user's selection input; measuring hearing habits that include an external noise level and an exposure time in the hear mode and a music volume level and an exposure time in the music mode; and analyzing the hearing habits and performing personalized monitoring for hearing improvement of each of the user's right ear and left ear in the hear mode and the music mode.

Also, the auditory monitoring method according to an example embodiment of the present invention may further include testing hearing of each of the user's right ear and left ear, determining a hearing loss level of the user based on test results, and setting a customized decibel that complements the hearing of each of the user's right ear and left ear.

Also, the auditory monitoring method according to an example embodiment of the present invention may further include controlling a personalized hearing status using a customized decibel that complements the hearing of the user by amplifying or reducing a decibel of the user's right ear and left ear in each situation of voice, television (TV) sound, and external sound.

An auditory monitoring system for monitoring a hearing status of a user in linkage with a hearing aid earphone according to an example embodiment of the present invention includes a detection unit configured to detect a bear mode of a hearing aid function and a music mode of an earphone function according to the user's selection input; a measurement unit configured to measure hearing habits that include an external noise level and an exposure time in the hear mode and a music volume level and an exposure time in the music mode; and a monitoring unit configured to analyze the hearing habits and to perform personalized monitoring for hearing improvement of each of the user's right ear and left ear in the hear mode and the music mode.

Also, the auditory monitoring system according to an example embodiment of the present invention may further include a control unit configured to test hearing of each of the user's right ear and left ear, to determine a hearing loss level of the user based on test results, and to set a customized decibel that complements the hearing of each of the user's right ear and left ear.

### Effect

According to example embodiments of the present invention, it is possible to verify hearing habits of a user in a hear mode of a hearing aid function and a music mode of an earphone function in linkage with a hearing aid earphone (or hearing aid) and to provide a personalized monitoring service for hearing improvement.

According to example embodiments of the present invention, it is possible to minimize hearing burden of a user and to improve a hearing function by providing a personalized monitoring service that automatically turns ON a noise cancellation function or pushes a notification for a pattern in which the user frequently encounters noise based on the hearing habits of the user.

### BRIEF DESCRIPTION OF DRAWINGS

FIG. 1 illustrates an example of describing a network environment according to an example embodiment of the present invention.

FIG. 2 illustrates an example of describing an internal configuration of an electronic device and a server illustrated in FIG. 1.

FIG. 3 is a flowchart illustrating an auditory monitoring method according to an example embodiment of the present invention.

FIGS. 4A to 7 illustrate application examples through an application according to an example embodiment of the present invention.

FIG. 8 illustrates a configuration of an auditory monitoring system according to an example embodiment of the present invention.

### BEST MODE

Advantages and features of the present invention and methods to achieve the same will become clear with reference to example embodiments described in detail along with the accompanying drawings. However, the present invention is not limited to example embodiments disclosed blow and may be implemented in various forms. Here, the example embodiments are provided to make the disclosure of the present invention complete and to fully inform one of ordinary skill in the art to which the present invention pertains of the scope of the present invention and the present invention is defined by the scope of the claims.

The terms used herein are to explain the example embodiments and not to be limiting of the present invention. Herein, the singular forms “a” “an.” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, and/or elements.

Unless otherwise defined herein, all terms used herein (including technical or scientific terms) have the same meanings as those generally understood by one of ordinary skill in the art. Also, terms defined in dictionaries generally used should be construed to have meanings matching contextual meanings in the related art and are not to be construed as an ideal or excessively formal meaning unless otherwise defined herein.

Hereinafter, example embodiments of the present invention will be described in detail with reference to the accompanying drawings. Like reference numerals refer to like components and a repeated description related thereto will be omitted.

An auditory monitoring method and system according to an example embodiment of the present invention relates to analyzing hearing habits in a hear mode and a music mode in linkage with a hearing aid earphone and providing a personalized monitoring service for hearing improvement.

Here, the hearing aid earphone according to an example embodiment of the present invention may be a Bluetooth earphone worn on each of the user's left ear and right ear, or may be a different type of earphone or headphone. However, any type of earphone linkable to an application in the user's terminal may be employed.

The terminal (or electronic device) may be at least one of the user's smartphone, desktop personal computer (PC), mobile phone, personal digital assistant (PDA), laptop computer, and tablet PC, and may monitor a hearing status of the user from the hearing aid earphone through an application linked to the hearing aid earphone. Here, the present invention may receive information according to the user's selection input through an application in a portable terminal held by the user and the terminal may include a screen-type display capable of performing a predetermined function set operation through a screen that includes a touch-sensing area and may be a device that includes at least one physical button or virtual button. Therefore, types and forms of the terminal are not limited thereto.

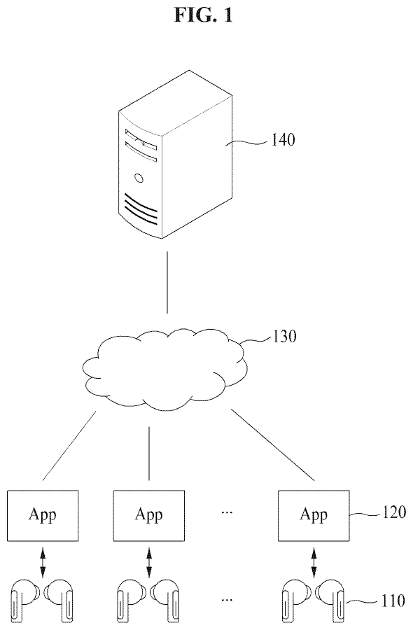

Hereinafter, the present invention is described with reference to FIGS. 1 to 8.

FIG. 1 illustrates an example of describing a network environment according to an example embodiment of the present invention. The network environment of FIG. 1 illustrates an example of including a plurality of ear aid earphones 110, a plurality of electronic devices 120, a server 140, and a network 130. However, FIG. 1 illustrates an example of explaining the present invention and the number of electronic devices or the number of servers is not limited to FIG. 1.

The plurality of electronic devices 120 may be mobile terminals implemented as computer devices. Examples of the plurality of electronic devices 120 may include a smartphone, a mobile phone, a tablet personal computer (PC), a navigation, a computer, a laptop computer, a digital broadcasting terminal, a personal digital assistant (PDA), a portable multimedia player (PMP), a user wearable device, and the like. For example, each of the electronic devices 120 may include an application capable of performing data communication with the server 140 and the hearing aid earphone 110, and may communicate with the server 140 through the network 130 using a wired or wireless communication scheme. That is, the electronic device 120 of FIG. 1 may refer to the application.

The communication scheme is not limited and may include a near field wireless communication scheme between devices as well as a communication scheme using a communication network (e.g., a mobile communication network, wired Internet, wireless Internet, and a broadcasting network) includable in the network 130. For example, the network 130 may include at least one network among networks that include a personal area network (PAN), a local area network (LAN), a campus area network (CAN), a metropolitan area network (MAN), a wide area network (WAN), a broadband network (BBN), and the Internet. Also, the network 130 may include at least one of network topologies that include a bus network, a star network, a ring network, a mesh network, a star-bus network, a tree or hierarchical network, and the like. However, they are provided as examples only.

The server 140 may be implemented as a computer device or a plurality of computer devices that provides an instruction, a code, a file, content, and a service through communication with the plurality of electronic devices 120 over the network 130.

For example, the server 140 may provide a file for installing an application to the first electronic device 120 connected through the network 130. In this case, the first electronic device 120 may install the application using the file provided from the server 140. Also, the first electronic device 120 may connect to the server 140 under control of at least one program (e.g., browser or the installed application) or an operating system (OS) and may receive a service or content provided from the server 140. For example, when the first electronic device 120 transmits a service request message to the server 140 through the network 130 under control of the application, the server 140 may transmit a code corresponding to the service request message to the first electronic device 120 and the first electronic device 120 may provide content to a user by configuring and displaying a screen according to the code under control of the application.

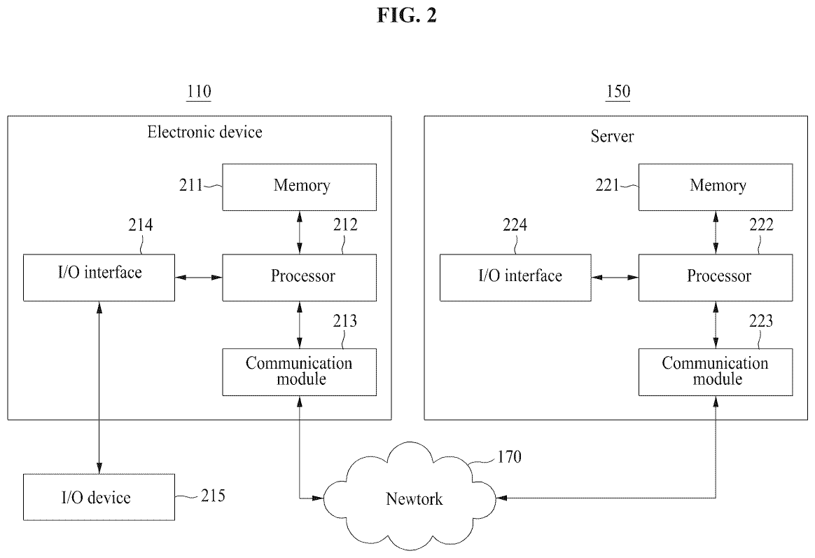

FIG. 2 illustrates an example of describing an internal configuration of an electronic device and a server illustrated in FIG. 1. An internal configuration of the first electronic device 120 as an example of a single electronic device that is a terminal carried by the user and an internal configuration of the server 140 as an example of a single server that communicates with the terminal of the user are described with reference to FIG. 2. Therefore, in the following, the first electronic device 120 refers to the terminal of the user and the server 140 refers to the server that communicates with the terminal of the user. Other electronic devices or servers may also have the same or similar internal configuration.

The first electronic device 120 and the server 140 may include memories 211 and 221, processors 212 and 222, communication modules 213 and 223, and input/output (I/O) interfaces 214 and 224, respectively. The memory 211, 221 may include a permanent mass storage device, such as a random access memory (RAM), a read only memory (ROM), and a disk drive, as a computer-readable recording medium. Also, an OS or at least one program code (e.g., code for an application installed and running on the first electronic device 110) may be stored in the memory 221, 221. Such software components may be loaded from another computer-readable recording medium separate from the memory 211, 221. The other computer-readable recording medium may include a computer-readable recording medium, for example, a floppy drive, a disk, a tape, a DVD/CD-ROM drive, a memory card, etc. According to other example embodiments, software components may be loaded to the memory 211, 221 through the communication module 213, 223, instead of the computer-readable recording medium. For example, at least one program may be loaded to the memory 211, 221 based on a program (e.g., the application) installed by files provided from developers or a file distribution system (e.g., the server 140) that distributes an installation file of the application over the network 130.

The processor 212, 222 may be configured to process instructions of a computer program by performing basic arithmetic operations, logic operations, and I/O operations. The instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the first electronic device 120 and the server 140 through the network 130 and may provide a function for communication with another electronic device or another server. For example, the processor 212 of the first electronic device 120 may deliver a request (e.g., search request) created based on a program code stored in a storage device, such as the memory 211, to the server 140 over the network 130 under control of the communication module 213. Inversely, a control signal or an instruction, content, a file, etc., provided under control of the processor 222 of the server 140 may be received at the first electronic device 120 through the communication module 213 of the first electronic device 120 by going through the communication module 223 and the network 130. For example, a control signal or an instruction of the server 140 received through the communication module 223 may be delivered to the processor 212 or the memory 211, and content or a file, etc., may be stored in a storage medium further includable in the first electronic device 120.

The I/O interface 214 may be a device used for interfacing with an I/O device 215. For example, an input device may include a device, such as a keyboard, a mouse, etc., and an output device may include a device, such as a display for displaying a communication session of an application. As another example, the I/O interface 214 may be a device for interfacing with an apparatus in which an input function and an output function are integrated into a single function, such as a touchscreen. As a specific example, when the processor 212 of the first electronic device 120 processes an instruction of a computer program loaded to the memory 211, a service screen or content configured using data provided from the server 140 or a second electronic device may be displayed on a display through the V/O interface 214. Likewise, when the processor 222 of the server 140 processes an instruction of a computer program loaded to the memory 221, the I/O interface 224 may output information configured using data provided from the server 140.

Also, according to other example embodiments, the first electronic device 120 and the server 140 may include the number of components greater than or less than the number of components shown in FIG. 2. However, there is no need to clearly illustrate many components according to the related art. For example, the first electronic device 120 may be configured to include at least a portion of the I/O device 215 or may further include other components, such as transceiver, a global positioning system (GPS) module, a camera, various types of sensors, and a database. As a specific example, when the first electronic device 120 is a smartphone, various components, such as an orientation sensor, an acceleration sensor or a gyro sensor, a camera, various types of physical buttons, a button using a touch panel, an I/O port, and a vibrator for vibration, which are generally included in the smartphone, may be further included in the first electronic device 120.

Hereinafter, example embodiments of an auditory monitoring method and system for analyzing hearing habits in a hear mode and a music mode in linkage with a hearing aid earphone and providing personalized monitoring for hearing improvement are described.

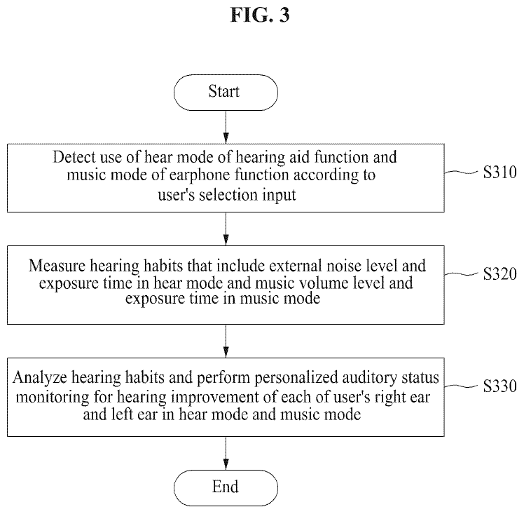

FIG. 3 is a flowchart illustrating an auditory monitoring method according to an example embodiment of the present invention.

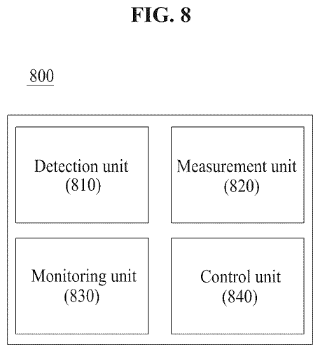

The method of FIG. 3 is performed by an auditory monitoring system according to an example embodiment of the present invention shown in FIG. 8.

Referring to FIG. 3, operation S310 detects a hear mode of a hearing aid function and a music mode of an earphone function according to a user's selection input.

Operation S310 may detect the hear mode for amplifying or reducing a decibel of external sound input through a hearing aid earphone according to a customized decibel set according to a hearing loss level of each of the user's right ear and left ear and thereby outputting the same. Here, the hear mode represents the hearing aid function and is a mode selected when the user wears a hearing aid earphone on each ear and then has a conversation with another person. The auditory monitoring method according to an example embodiment of the present invention may amplify or reduce the external sound according to the customized decibel that complements the hearing of each of the user's right ear and left ear and thereby output the same through the hearing aid earphone in the hear mode.

Also, operation S310 may detect the music mode for amplifying or reducing a decibel of music sound output through the hearing aid earphone according to the customized decibel and thereby outputting the same. The music mode represents the earphone function and is a mode selected when the user wears the hearing aid earphone on each ear and then listens to a song and may be a state in which a microphone (Mic) of the hearing aid earphone is locked. The auditory monitoring method according to an example embodiment of the present invention may amplify or reduce the music sound according to the customized decibel that complements the hearing of each of the user's right ear and left ear and thereby output the same through the hearing aid earphone in the music mode.

Here, the user may select the hear mode or the music mode and may also select both of the hear mode and the music mode.

Operation S320 measures hearing habits that include an external noise level and an exposure time in the hear mode and a music volume level and an exposure time in the music mode.

Operation S320 may measure the external noise level measured as external sound input through the hearing aid earphone and the exposure time exposed to noise in the hear mode and may measure the music volume level measured as music sound through the hearing aid earphone and the exposure time exposed to music in the music mode. When the user wears the hearing aid earphone and then executes at least one of the hear mode and the music mode, operation S320 of the auditory monitoring method according to an example embodiment of the present invention measures a noise level applied to the user and an exposure time exposed to noise while executing the mode. Here, the noise level represents noise of decibel outside a preset range based on the user's hearing loss level and the level may be set based on intensity of noise outside the preset range. Therefore, the level value and range are not limited. Also, the noise exposure time may represent an amount of time exposed to the aforementioned noise level.

Operation S330 analyzes the hearing habits and performs personalized monitoring for hearing improvement of each of the user's right ear and left ear in the hear mode and the music mode.

Operation S330 may analyze the measured hearing habits and may calculate the average exposure value of the external sound and the music sound output to the user's right ear and left ear and quantify the exposure time and the average exposure value by day or by hour in the hear mode and the music mode. In detail, operation S330 may verify a pattern in a specific time zone in which the user is exposed to high external noise depending on the user's hearing and music listening habits using the hear mode and the music mode. For example, when using public transportation such as during commute time, the user may be exposed to high external noise and operation S330 may express, as a pattern, that the user is exposed to high noise on weekdays and during commute time.

Accordingly, operation S330 may provide hearing status feedback for hearing improvement of the user by turning ON a noise cancellation function or pushing a notification in a specific time zone in which the user is exposed to relatively high external noise, based on the exposure time and the average exposure value quantified by day or by hour. For example, operation S330 may minimize exposure by turning ON the noise cancellation function on weekdays and during commute time to reduce a noise decibel and may also notify the user by pushing a notification that it is a time zone for exposure to noise.

Also, the auditory monitoring method according to an example embodiment of the present invention may further include testing hearing of each of the user's right ear and left ear, determining a hearing loss level of the user based on test results, and setting a customized decibel that complements the hearing of each of the user's right ear and left ear (not shown).

The setting of the customized decibel may test the hearing of each of the user's right ear and left ear. For example, in linkage with a left hearing aid earphone and a right hearing aid earphone worn on the user's left ear and right ear, respectively, the hearing of each of the user's both ears may be tested. Then, a hearing status of the user may be determined based on test results and the customized decibel that complements the hearing of each of the user's right ear and left ear may be set according to the hearing status of the user. For example, even a person with difficulty of hearing may have a different hearing status for each of the left ear and the right ear. Therefore, the present invention may determine a hearing status of each of left and right ears suitable for the user, may correct a frequency suitable for each of the left ear and the right ear with an equalizer (EQ), and may set the customized decibel in the music sound and the external sound.

As described above, the present invention may amplify or reduce sound according to the customized decibel that complements the hearing of each of the user's right ear and left ear depending on the hear mode or the music mode, and the combination mode in which the hear mode and the music mode are combined.

Also, the auditory monitoring method according to an example embodiment of the present invention may further include controlling a personalized hearing status using a customized decibel that complements hearing of the user by amplifying or reducing a decibel of the user's right ear and left ear in each situation of voice, TV sound, and external sound (not shown). For example, the user may adjust a decibel of voice (or sound), TV sound, and external noise sound detected in the hear mode to be suitable for each situation and the controlling operation may proportionally control decibel amplification or reduction of the right ear and the left ear according to the user's selection input based on the user's customized decibel. In more detail, when the customized decibel of the user's left ear is set to 10 and the customized decibel of the user's right ear is set to 3 at a ratio of 10 to 3, the controlling operation may proportionally control decibel amplification or reduction by setting the decibel of the right ear to 6.

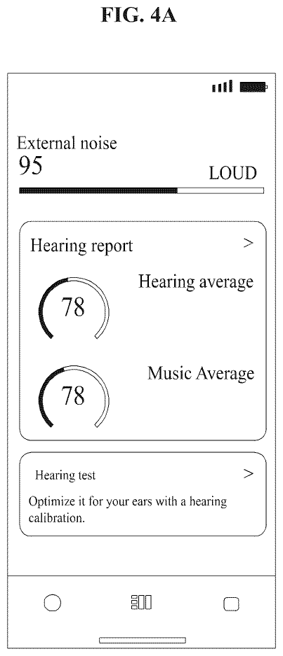

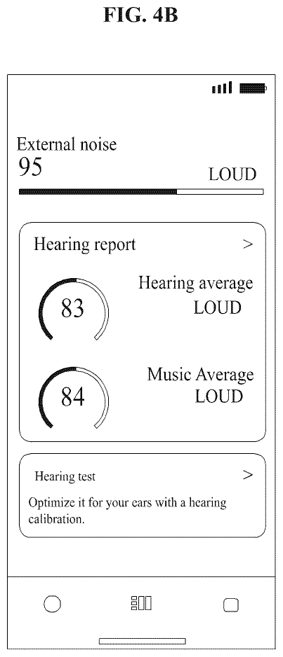

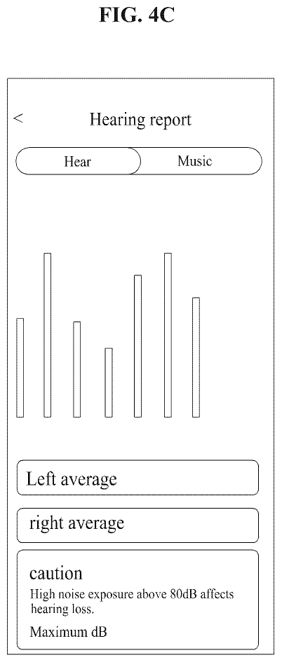

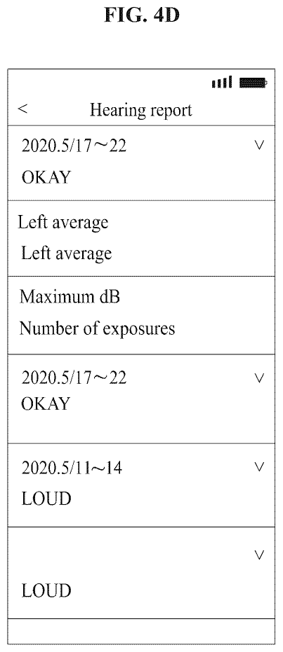

FIGS. 4A to 7 illustrate application examples through an application according to an example embodiment of the present invention.

Referring to FIGS. 4A to 4D, auditory monitoring technology according to an example embodiment of the present invention may measure an external noise level and an exposure time in a hear mode and a music mode and may provide monitoring results to an application in a terminal carried by a user, using a phrase, such as “OKAY” or “LOUD” as shown in FIGS. 4A and 4B. Also, a hearing report according to the user's hearing habits may calculate and quantify the average value in the right ear and the left ear by day or by time as shown in FIGS. 4C and 4D.

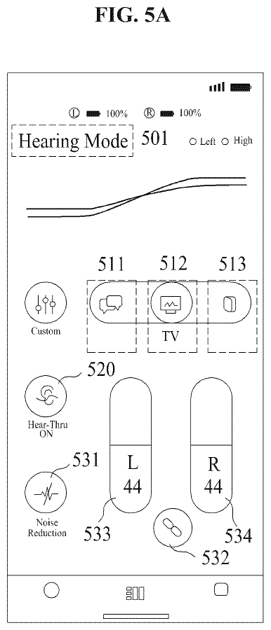

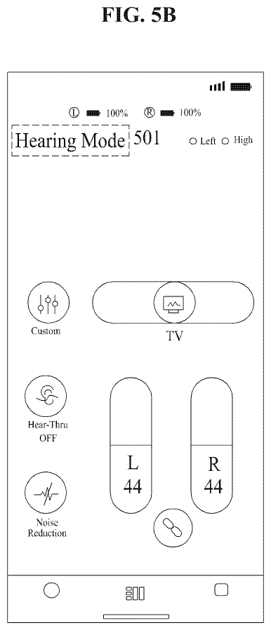

The auditory monitoring technology according to an example embodiment of the present invention may quantify and provide monitoring results in the hear mode and the music mode to the application in the terminal of the user. Here, describing the monitoring results in the hear mode with reference to FIGS. 5A and 5B, a voice amplification amount graph 501 of each of a left hearing aid earphone and a right hearing aid earphone in the hear mode is illustrated, and a personalized hearing status may be controlled at a customized decibel that complements hearing of the user by amplifying or reducing a decibel of the right ear and the left ear in each situation of voice (talk) 511, TV sound 512, and external sound (outdoor) 513 in response to the user's selection input (custom). Also, the user may adjust a decibel in a left ear 533 and a right ear 534 in each mode by turning ON/OFF a hear-through mode 520 for listening to the external sound 513 and by turning ON/OFF a noise reduction mode 531. Here, the present invention may proportionally provide decibel amplification or reduction according to the user's selection input depending on a ratio control mode 532. For example, if the user increases a decibel of the left ear to 20 in a situation in which a customized decibel of the user's left ear is set to 10 and a customized decibel of the user's right ear is set to 3 at a ratio of 10 to 3, the present invention proportionally controls decibel amplification or reduction by setting a decibel of the right ear to 6.

Accordingly, the present invention may provide clear voice in which noise undesired by the user is removed by highlighting a decibel of a voice frequency domain in the voice (or talk) 511. Also, the present invention may emphasize only a specific frequency of sound coming from a TV by adjusting a decibel of the TV sound 512 and may provide clearer TV sound quality accordingly. Also, the present invention may protect hearing of the user and, at the same time, may receive necessary information from outside by minimizing an unnecessary noise decibel in the external sound 513 and by amplifying a decibel of sound capable of detecting danger, such as car horn, ambulance sounding, and guidance sound.

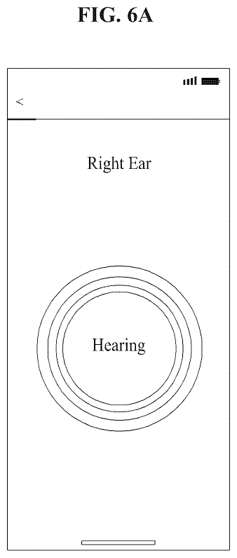

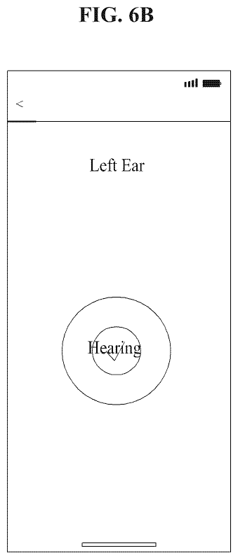

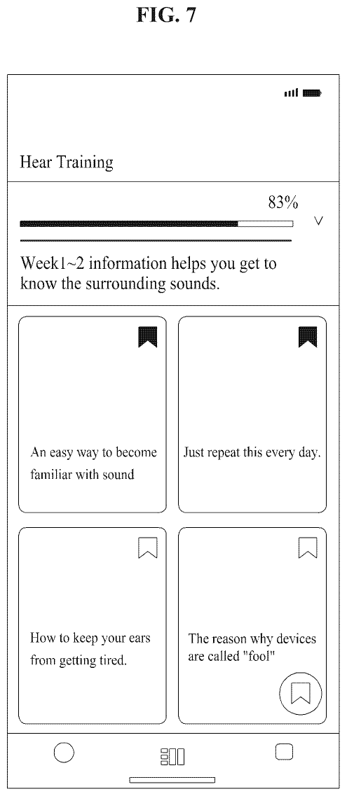

The auditory monitoring technology according to an example embodiment of the present invention may test the hearing of each of the user's right ear and left ear (see FIGS. 6A and 6B) and may provide various hearing aid application programs for users not familiar with the hearing aid (see FIG. 7).

FIG. 8 illustrates a configuration of an auditory monitoring system according to an example embodiment of the present invention and illustrates a conceptual configuration of a server that performs the method of FIGS. 1 to 7.

Referring to FIG. 8, an auditory monitoring system 800 according to an example embodiment of the present invention includes a detection unit 810, a measurement unit 820, a monitoring unit 830, and a control unit 840.

The detection unit 810 detects a hear mode of a hearing aid function and a music mode of an earphone function according to a user's selection input.

The detection unit 810 may detect the hear mode for amplifying or reducing a decibel of external sound input through a hearing aid earphone according to a customized decibel set according to a hearing loss level of each of the user's right ear and left ear and thereby outputting the same. Here, the hear mode represents the hearing aid function and is a mode selected when the user wears a hearing aid earphone on each ear and then has a conversation with another person. The auditory monitoring system 800 according to an example embodiment of the present invention may amplify or reduce the external sound according to the customized decibel that complements the hearing of each of the user's right ear and left ear and thereby output the same through the hearing aid earphone in the hear mode.

Also, the detection unit 810 may detect the music mode for amplifying or reducing a decibel of music sound output through the hearing aid earphone according to the customized decibel and thereby outputting the same. The music mode represents the earphone function and is a mode selected when the user wears the hearing aid earphone on each ear and then listens to a song and may be a state in which a microphone (Mic) of the hearing aid earphone is locked. The auditory monitoring system 800 according to an example embodiment of the present invention may amplify or reduce the music sound according to the customized decibel that complements the hearing of each of the user's right ear and left ear and thereby output the same through the hearing aid earphone in the music mode.

Here, the user may select the hear mode or the music mode and may also select both of the hear mode and the music mode.

The measurement unit 820 measures hearing habits that include an external noise level and an exposure time in the hear mode and a music volume level and an exposure time in the music mode.

The measurement unit 820 may measure the external noise level measured as external sound input through the hearing aid earphone and the exposure time exposed to noise in the hear mode and may measure the music volume level measured as music sound through the hearing aid earphone and the exposure time exposed to music in the music mode. When the user wears the hearing aid earphone and then executes at least one of the hear mode and the music mode, the measurement unit 820 according to an example embodiment of the present invention measures a noise level applied to the user and an exposure time exposed to noise while executing the mode. Here, the noise level represents noise of decibel outside a preset range based on the user's hearing loss level and the level may be set based on intensity of noise outside the preset range. Therefore, the level value and range are not limited. Also, the noise exposure time may represent an amount of time exposed to the aforementioned noise level.

The monitoring unit 830 analyzes the hearing habits and performs personalized monitoring for hearing improvement of each of the user's right ear and left ear in the hear mode and the music mode.

The monitoring unit 830 may analyze the measured hearing habits and may calculate the average exposure value of the external sound and the music sound output to the user's right ear and left ear and quantify the exposure time and the average exposure value by day or by hour in the hear mode and the music mode. In detail, the monitoring unit 830 may verify a pattern in a specific time zone in which the user is exposed to high external noise depending on the user's hearing and music listening habits using the hear mode and the music mode. For example, when using public transportation such as during commute time, the user may be exposed to high external noise and the monitoring unit 830 may express, as a pattern, that the user is exposed to high noise on weekdays and during commute time.

Accordingly, the monitoring unit 830 may provide hearing status feedback for hearing improvement of the user by turning ON a noise cancellation function or pushing a notification in a specific time zone in which the user is exposed to relatively high external noise, based on the exposure time and the average exposure value quantified by day or by hour. For example, the monitoring unit 830 may minimize exposure by turning ON the noise cancellation function on weekdays and during commute time to reduce the noise decibel and may also notify the user by pushing a notification that it is a time zone for exposure to noise.

The control unit 840 may test hearing of each of the user's right ear and left ear, may determine a hearing loss level of the user based on test results, and may set a customized decibel that complements the hearing of each of the user's right ear and left ear.

The control unit 840 may test the hearing of each of the user's right ear and left ear. For example, in linkage with a left hearing aid earphone and a right hearing aid earphone worn on the user's left ear and right ear, respectively, the control unit 840 may test the hearing of each of the user's both ears. Then, the control unit 840 may determine a hearing status of the user based on test results and may set the customized decibel that complements the hearing of each of the user's right ear and left ear according to the hearing status of the user. For example, even a person with difficulty of hearing may have a different hearing status for each of the left ear and the right ear. Therefore, the control unit 840 may determine a hearing status of each of left and right ears suitable for the user, may correct a frequency suitable for each of the left ear and the right ear with an equalizer (EQ), and may set the customized decibel in the music sound and the external sound.

As described above, the control unit 840 may amplify or reduce sound according to the customized decibel that complements the hearing of each of the user's right ear and left ear depending on the hear mode or the music mode, and the combination mode in which the hear mode and the music mode are combined.

Also, the control unit 840 may control a personalized hearing status using a customized decibel that complements hearing of the user by amplifying or reducing a decibel of the user's right ear and left ear in each situation of voice, TV sound, and external sound. For example, the user may adjust a decibel of voice (or sound), TV sound, and external noise sound detected in the hear mode to be suitable for each situation and the control unit 840 may proportionally control decibel amplification or reduction of the right ear and the left ear according to the user's selection input based on the user's customized decibel. In more detail, when the customized decibel of the user's left ear is set to 10 and the customized decibel of the user's right ear is set to 3 at a ratio of 10 to 3, the control unit 840 may proportionally control decibel amplification or reduction by setting the decibel of the right ear to 6.

Although the description is omitted in the system of FIG. 8, each component that constitutes FIG. 8 may include all contents described with reference to FIGS. 1 to 7, which is apparent to those skilled in the art.

The systems or the apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the example embodiments may be configured in a form of program instructions performed through various computer devices and recorded in computer-readable recording media. The media may also include, alone or in combination with the program instructions, data files, data structures, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of program instructions include both a machine code, such as produced by a compiler, and files containing a higher-level code that may be executed by the computer using an interpreter. The hardware device may be configured to operate as at least one software module, or vice versa.

### MODE

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved although the described techniques are performed in different order, and/or although components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. An auditory monitoring method for monitoring a hearing status of a user in linkage with a hearing aid earphone, the auditory monitoring method comprising:
detecting a hear mode of a hearing aid function and a music mode of an earphone function according to the user's selection input;
measuring bearing habits that include an external noise level and an exposure time in the hear mode and a music volume level and an exposure time in the music mode; and
analyzing the hearing habits and performing personalized monitoring for hearing improvement of each of the user's right ear and left ear in the hear mode and the music mode.

2. The auditory monitoring method of claim 1, wherein the detecting comprises detecting the hear mode for amplifying or reducing a decibel of external sound input through the hearing aid earphone according to a customized decibel set according to a hearing loss level of each of the user's right ear and left ear and thereby outputting the same.

3. The auditory monitoring method of claim 2, wherein the detecting comprises detecting the music mode for amplifying or reducing a decibel of music sound output through the hearing aid earphone according to the customized decibel and thereby outputting the same.

4. The auditory monitoring method of claim 1, wherein the measuring comprises measuring the external noise level measured as external sound input through the hearing aid earphone and the exposure time exposed to noise in the hear mode and measuring the music volume level measured as music sound through the hearing aid earphone and the exposure time exposed to music in the music mode.

5. The auditory monitoring method of claim 4, wherein the monitoring comprises analyzing the measured hearing habits and calculating the average exposure value of the external sound and the music sound output to the user's right ear and left ear and quantifying the exposure time and the average exposure value by day or by hour in the hear mode and the music mode.

6. The auditory monitoring method of claim 5, wherein the monitoring comprises providing hearing status feedback for hearing improvement of the user by turning ON a noise cancellation function or pushing a notification in a specific time zone in which the user is exposed to relatively high external noise, based on the exposure time and the average exposure value quantified by day or by hour.

7. The auditory monitoring method of claim 1, further comprising:
testing hearing of each of the user's right ear and left ear, determining a hearing loss level of the user based on test results, and setting a customized decibel that complements the hearing of each of the user's right ear and left ear.

8. The auditory monitoring method of claim 1, further comprising:
controlling a personalized hearing status using a customized decibel that complements the hearing of the user by amplifying or reducing a decibel of the user's right ear and left ear in each situation of voice, television (TV) sound, and external sound.

9. An auditory monitoring system for monitoring a hearing status of a user in linkage with a hearing aid earphone, the auditory monitoring system comprising:
a detection unit configured to detect a hear mode of a hearing aid function and a music mode of an earphone function according to the user's selection input;
a measurement unit configured to measure hearing habits that include an external noise level and an exposure time in the hear mode and a music volume level and an exposure time in the music mode; and
a monitoring unit configured to analyze the hearing habits and to perform personalized monitoring for hearing improvement of each of the user's right ear and left ear in the hear mode and the music mode.

10. The auditory monitoring system of claim 9, wherein the detection unit is configured to detect the hear mode for amplifying or reducing a decibel of external sound input through the hearing aid earphone according to a customized decibel set according to a hearing loss level of each of the user's right ear and left ear and thereby outputting the same.

11. The auditory monitoring system of claim 10, wherein the detection unit is configured to detect the music mode for amplifying or reducing a decibel of music sound output through the hearing aid earphone according to the customized decibel and thereby outputting the same.

12. The auditory monitoring system of claim 9, wherein the measurement unit is configured to measure the external noise level measured as external sound input through the hearing aid earphone and the exposure time exposed to noise in the hear mode and to measure the music volume level measured as music sound through the hearing aid earphone and the exposure time exposed to music in the music mode.

13. The auditory monitoring system of claim 12, wherein the monitoring unit is configured to analyze the measured hearing habits and calculate the average exposure value of the external sound and the music sound output to the user's right ear and left ear and to quantify the exposure time and the average exposure value by day or by hour in the hear mode and the music mode.

14. The auditory monitoring system of claim 13, wherein the monitoring unit is configured to provide hearing status feedback for hearing improvement of the user by turning ON a noise cancellation function or pushing a notification in a specific time zone in which the user is exposed to relatively high external noise, based on the exposure time and the average exposure value quantified by day or by hour.

15. The auditory monitoring system of claim 9, further comprising:
a control unit configured to test hearing of each of the user's right ear and left ear, to determine a hearing loss level of the user based on test results, and to set a customized decibel that complements the hearing of each of the user's right ear and left ear.

16. The auditory monitoring system of claim 15, wherein the control unit is configured to control a personalized hearing status using a customized decibel that complements the hearing of the user by amplifying or reducing a decibel of the user's right ear and left ear in each situation of voice, television (TV) sound, and external sound.
